(19) United States
(12) Patent Application Publication
(10) Pub. No.: US 2026/0158684 A1
(43) Pub. Date: Jun. 11, 2026

(54) SYSTEM FOR AIDING THE PROGRAMMING OF A ROBOT

(71) Applicant: COMMISSARIAT À L'ENERGIE ATOMIQUE ET AUX ENERGIES ALTERNATIVES, PARIS (FR)

(72) Inventor: Florian GOSSELIN, GIF SUR YVETTE (FR)

(21) Appl. No.: 19/412,704

(22) Filed: Dec. 8, 2025

(30) Foreign Application Priority Data
Dec. 9, 2024 (FR) 2413695

(51) Int. Cl. B25J 19/06; B25J 9/16

(52) U.S. Cl. CPC B25J 19/06; B25J 9/1661; B25J 9/1697

(57) ABSTRACT

A system for aiding the programming of a robot capable of carrying out at least one action on an entity includes: a first designation device, to allow an operator to designate an entity by projecting a first pattern onto the entity; a visibility confirmation device, to provide the operator with a visual rendering that the entity is visible to the robot; at least one reachability confirmation device, to provide the operator with a visual rendering that the entity is able to be reached by an effector of the robot; a human-machine interface, to receive at least one command, provided by the operator, for interaction of the robot with the entity.

### CROSS-REFERENCE TO RELATED APPLICATION

This application claims priority to foreign French patent application No. FR 2413695, filed on Dec. 9, 2024, the disclosure of which is incorporated by reference in its entirety.

### FIELD OF THE INVENTION

The invention relates to the field of the programming of robots capable of carrying out at least one action (a physical action or a measurement or inspection) on an entity using an effector, a tool or a measuring means. The invention may be applied in the field of industry, agriculture, maintenance, or to any application that requires designation of a robot-specific area as part of the programming of said robot.

### BACKGROUND

Robot programming has long been based on the use of dedicated computer languages used to program robots offline in an offline programming (OLP) approach, the programs being able to be validated on site or upstream using dedicated CAD software (for example RobCAD, RoboDK, Robotstudio). However, this traditional approach requires qualified personnel (with skills in robotics and computer science), and is a lengthy and tedious process (upstream to program the robots in a simulated environment, and then on site to adjust the programs to the conditions encountered in reality).

To avoid these pitfalls and facilitate robot programming, engineers and researchers proposed new paradigms based on programming by demonstration or programming by imitation in the 2000s and 2010s:

Programming by demonstration, generally used in association with collaborative robots able to work in contact with humans and to be moved by them, consists in moving the robot “by hand” so as to bring it to successive key positions or along a trajectory associated with the task to be carried out, and then in asking the robot to “replay” these positions or this trajectory in order to carry out the task (directly if trajectories have been learned, or after the generation of trajectories that “smooth” and optimize passage through the successive demonstration points if waypoints have been learned). This approach, which is implemented directly on site, is faster and more intuitive than OLP, but requires “replaying” the whole task with the robot one or more times (multiple demonstrations are often carried out, from which statistical averages, which serve as references, are extracted). For complex tasks, this may be a relatively lengthy process, and if the robot is not particularly transparent (that is to say is not reversible or not particularly reversible, not easy to move by hand), the desired passage configurations may be difficult to achieve or not particularly precise. To overcome this difficulty, multi-stage approaches have been proposed, allowing demonstrations to be carried out in multiple stages (for example the approach starts by showing the robot the trajectory to be followed, and then the orientation to be complied with along this trajectory, and then the reference speed). This makes things easier but also makes the process even lengthier, and does not completely solve the precision problems if the robot is difficult to move.

Programming by imitation makes it possible to overcome this problem. This consists in carrying out the task by moving no longer the robot, but a hand-held tool (or the hand itself), the movements of which are measured using an additional motion capture system. Under these conditions, the reference trajectory may be realized more naturally, without being hampered in any way by the robot. However, it is then necessary to ensure that the robot will be able to realize said trajectory and, with the human arm being less precise than a robot, it may be necessary to “re-edit” the passage configurations or trajectories that have been learned in order to adjust them to precise values (this drawback also applies for approaches by demonstration).

Thus, whether for approaches by demonstration or by imitation, it is often difficult to ensure the precision of specific passage configurations, and it is often necessary to “re-edit” the learned configurations in order to adjust them. For this purpose, use is most often made of teach pendants (learning consoles equipped with touchscreens for editing fields associated with various parameters, including these passage positions). These teach pendants also make it possible to program simple trajectories of the robot, in terms of its articulations or its effector (for example pure rotational or translational movements). The use of such pendants, promoted as an “intuitive” approach by robot manufacturers who offer them, is thus limited to simple tasks.

Finally, more recently, advances in artificial intelligence (AI) tools and large language models (LLMs) have led some teams to propose to program robots using high-level instructions given in chats (use of prompts) or orally, the program being generated automatically by generative AI. This approach is highly intuitive and makes it possible to give relatively general instructions (for example “go to the kitchen and get me an apple”), but requires significant computational means and large quantities of data. Beyond this, questions still arise regarding their reliability (for example hallucinations of generative AI). Finally, these approaches:
are not suitable for all tasks. They are highly suitable when the orders are clear and explicit and the designated objects differ from one another or the choice of one of them is not particularly important (for example “get me a bag of crisps”), but they are less effective when the orders are more difficult to formulate, for example when designating one object from among N of the same type, or a location in an indistinct area. As would be the case with a human collaborator, lengthy explanations may then be necessary (for example “this nut needs to be tightened” is not sufficient, and it is necessary to be more precise, for example “the nut third from the bottom and second from the left needs to be tightened” with possible errors), or lengthy exchanges (“not that one, the one next to it”). The designation of the objective may even be very difficult to formulate simply, or even impossible (for example precise area to be inspected in non-destructive inspection on a flat object without this area having a distinctive sign).
are not suitable for all contexts. The use of prompt-based chats is conceivable in an office, but not in a factory (manufacturing robotics), in a field (agricultural robotics) or in another constrictive environment, and the use of a voice interface is not a solution when the environment is noisy (such as in a factory, for example).

It should be noted that this approach based on high-level objective designation also impacts OLP software, with the integration of firstly efficient trajectory generation solutions (such as the one developed for example by Realtime Robotics) used to designate only the start and end configurations (and possibly a few passage configurations), and no longer to program the complete trajectory, and secondly contextual programming solutions (for example when clicking on an object, the software tells us what can be done with it). These solutions facilitate OLP, but do not completely solve the problem. Indeed, they require a digital twin of the cell to be set up, this being a relatively lengthy process and not being feasible/profitable for an SME, and/or for a simple task. Moreover, they require qualified personnel (computer scientists) and do not resolve the necessary adjustments when the programmed trajectory is brought on site.

### SUMMARY OF THE INVENTION

The invention aims to overcome the abovementioned drawbacks.

One subject of the invention is therefore a system for aiding the programming of a robot capable of carrying out at least one action on an entity, comprising:
a first designation device, configured to allow an operator to designate an entity by projecting a first pattern onto the entity;
a visibility confirmation device, configured to provide the operator with a visual rendering that the entity is visible to the robot;
at least one reachability confirmation device, configured to provide the operator with a visual rendering that the entity is able to be reached by an effector of the robot;
a human-machine interface, configured to receive at least one command, provided by the operator, for interaction of the robot with the entity.

Advantageously, the visibility confirmation device comprises a vision system and means for projecting a second pattern onto the first pattern if the first pattern is within the field of view of the vision system.

Advantageously, the reachability confirmation device comprises means for projecting at least one third pattern onto the first pattern if the entity is able to be reached by the effector.

Advantageously, the first pattern, the second pattern and the third pattern are different from one another.

Advantageously, the visibility confirmation device is configured to modify the colour of the second pattern depending on whether or not the entity is visible to the vision system.

Advantageously, the visibility confirmation device is configured to modify the colour of the second pattern depending on the convergence of the first pattern and the second pattern.

Advantageously, the reachability confirmation device is configured to modify the colour of the third pattern depending on whether or not the entity is able to be reached by the robot or the effector.

Advantageously, the reachability confirmation device is configured to modify the colour of the third pattern depending on the convergence of the first pattern and the third pattern.

Advantageously, the visibility confirmation device comprises a first servo-control unit configured to move the robot and/or to modify the orientation of the means for projecting a second pattern so as to minimize a discrepancy between the first pattern and the visual rendering of the visible character of the entity.

Advantageously, the reachability confirmation device comprises a second servo-control unit configured to move the robot and/or the effector of the robot and/or to modify the orientation of the means for projecting at least one third pattern so as to minimize a discrepancy between the first pattern and the visual rendering of the reachable character of the entity.

Advantageously, the second servo-control unit is configured to take the second pattern as a fixed reference to move the robot and/or the effector of the robot and/or to modify the orientation of the means for projecting at least one third pattern.

Advantageously, the visual rendering of the reachable character of the designated area comprises displaying contextual icons by way of the human-machine interface, the icons being displayed depending on a reachability context of the effector with respect to the entity.

Advantageously, the first designation device comprises a non-point light source coupled to a perforated mask.

Advantageously, the first pattern comprises a cross.

Advantageously, the system comprises a projection device configured to illuminate the entire field of view of the robot.

Advantageously, the projection device is configured to project a grid of lines the spacing between which is adjustable depending on the desired precision.

Advantageously, the projection device is used both to illuminate the field of view of the robot and to project at least one of the patterns from among the pattern of the visual rendering of the visible character of the entity and the pattern of the visual rendering of the reachable character of the entity.

Advantageously, the first designation device, the visibility confirmation device and/or the reachability confirmation device comprise a means for correcting the shape of the first pattern, of the visual rendering of the visible character of the entity and/or of the visual rendering of the reachable character of the entity, respectively.

Advantageously, the system comprises an image processing software unit configured to determine the distance between the effector and the entity, or a distance sensor configured to determine the distance to the entity, the correction means applying a correction depending on the determined distance.

Advantageously, the visibility confirmation device and the reachability confirmation device are integrated into one and the same structure, which is configured to project both the pattern of the visual rendering of the visible character of the entity and the pattern of the visual rendering of the reachable character of the entity.

Advantageously, the fact that an effector of the robot is able to reach the entity is determined through knowledge of the positioning of the vision system, in order to calculate the coordinates of the entity in the reference frame of the robot, and the movements necessary for the effector to reach the entity.

The invention also relates to a method for aiding the programming of a robot capable of carrying out at least one action on an entity, comprising:
a first step of designating an entity by projecting a first pattern onto the entity;
a second step of providing a visual rendering that the entity is visible to the robot;
a third step of providing a visual rendering that the entity is able to be reached by an effector of the robot;
a fourth step of receiving at least one command, provided by the operator, for interaction of the robot with the entity.

The invention also relates to a computer program comprising instructions for carrying out the abovementioned method when the program is executed by a processor.

The invention also relates to a processor-readable recording medium on which there is recorded a program comprising instructions for carrying out the abovementioned method when the program is executed by a processor.

### BRIEF DESCRIPTION OF THE DRAWINGS

Other features, details and advantages of the invention will become apparent on reading the description provided with reference to the appended drawings, which are given by way of example.

FIG. 1 and FIG. 2 illustrate two views of the main components of a first embodiment of the system according to the invention.

FIG. 3 illustrates one example of projecting patterns onto the entity.

FIG. 4 illustrates embodiments of first patterns.

FIG. 5 illustrates different shapes between the first pattern and the second and third patterns.

FIG. 6 illustrates one embodiment of personalizing the patterns.

FIG. 7 illustrates embodiments of the installation of the visibility confirmation device and of the reachability confirmation device.

FIG. 8 and FIG. 9 illustrate one embodiment of the operation of the designation devices arranged on the robot.

FIG. 10 illustrates one embodiment of the system in which the robot comprises just one effector.

FIG. 11 illustrates one embodiment in which the visibility confirmation device is installed on a fixed element.

FIG. 12 illustrates one embodiment in which the visibility confirmation device is installed on a drone.

FIG. 13 illustrates various embodiments (A-F) of designation devices.

FIG. 14 illustrates one variant embodiment of the designation systems able to be arranged on the robot.

FIG. 15, FIG. 16 and FIG. 17 illustrate various embodiments of the first designation device.

FIG. 18 illustrates one embodiment of the visual rendering of the reachable character of the designated area and of the actions made possible by this reachable character in the form of a display of contextual icons.

FIG. 19 illustrates one embodiment of designating and validating multiple successive positions to be reached.

FIG. 20 illustrates one embodiment of projecting the field of view of the robot.

FIG. 21 illustrates one embodiment of designation assistance by projecting the field of view of the robot, taking into account depth of field.

FIG. 22 illustrates one embodiment of integrating a distance sensor into one of the designation devices.

FIG. 23 illustrates one embodiment of integrating a means for correcting the shape of the first pattern, of the second pattern and/or of the third pattern, respectively.

FIG. 24 illustrates one embodiment in which the second and third patterns are generated by one and the same designation device.

FIG. 25 illustrates one embodiment of using pattern projection devices to carry out visual servo-control.

### DETAILED DESCRIPTION

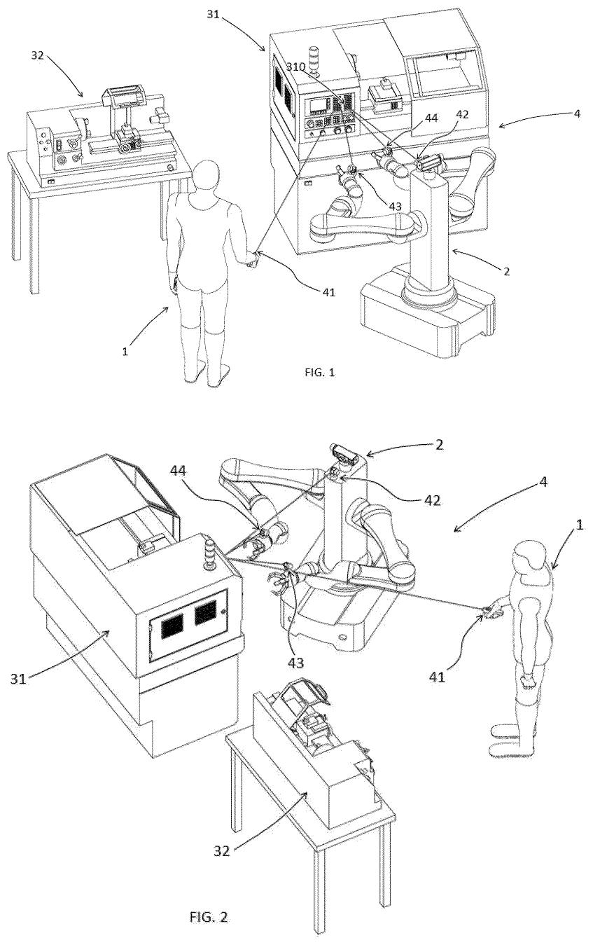

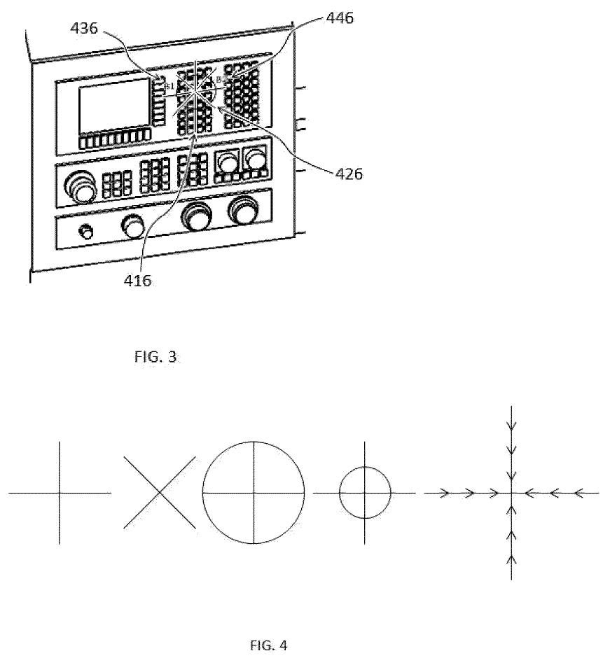

A first embodiment of the system 4 according to the invention, illustrated in two different views by FIGS. 1 and 2, comprises the following elements:
a first designation device 41, configured to allow an operator 1 to designate an entity 310 by projecting a first pattern 416 (FIG. 3) onto the entity 310. The entity is designated by gestures, in a manner simpler and more intuitive than via a computer mouse or touchscreen on a remote console, and in a manner more precise and explicit than via a chatbot;
a visibility confirmation device 42, configured to provide the operator with a visual rendering that the entity 310 is visible to the robot 2. The visibility confirmation device allows the operator to check, very easily and very quickly, whether the robot is able to see the target that they designate, and if necessary to move the robot or ask the robot to move in order to see it better;
at least one reachability confirmation device (43, 44), configured to provide the operator 1 with a visual rendering that the entity 310 is able to be reached by an effector of the robot 2. This makes it easy to show the operator whether the robot is able to reach the designated targets;
a human-machine interface allowing the operator 1 to send an instruction or command to the robot 2 in relation to the entity 310. The human-machine interface allows the operator to indicate the actions to be carried out on the designated objects. The human-machine interface may optionally be integrated into the first designation device 41, thereby making the system easier to use.

The instruction/command that the user enters via the human-machine interface is validated only if the visible character of the first pattern and the reachable character of the entity are confirmed.

This thus allows the operator to program the robot easily and quickly.

The designated entity with which the robot interacts may be of any kind, provided that the robot is able to interact therewith (physical action, remote observation, measurement, inspection, etc.). In the figures, the entity is represented by a part (for example a button) of a numerically controlled lathe, or of a machine tool (31, 32). The entity may also be a mechanical part or an object to be moved or inspected, in the field of control or logistics, or a plant (or an animal) or part of a plant (or of an animal), for an application of the invention to the field of agriculture.

The robot may be of any type, for example and without limitation a fixed robot, a mobile robot (with wheels, tracks or legs or combining any combination of wheels, tracks and legs, or else moving by sliding or lifting its base, for example on an air cushion) equipped with one or more robotic arms, or even without arms (notably to carry out inspection tasks), a flying or underwater robot equipped with one or more arms, or without arms, the robot and/or robotic arms being able to be of any type known to those skilled in the art, such as, for example and without limitation, a serial robot or a parallel robot or a robot having a mixed serial/parallel architecture, redundant or not, anthropomorphic or not, consisting of rigid or flexible articulated bodies or else of continuous material (soft robotics) or any combination of articulated and deformable parts.

The robot comprises at least one effector (which may notably take the form of a gripper, a tool or a measuring device depending on the field in question), and possibly an arm in order to move the effector. The effector arranged on the robot or at the end of the robot, in the case of a gripper, may also take any form known to those skilled in the art, such as, for example and without limitation, clamps with two parallel jaws, grippers with two, three or four or more fingers each having one, two or three or more movable bodies articulated together along axes of translation or rotation or any combination of axes of translation or rotation, with or without the ability to reconfigure the “fingers” in relation to the palm, anthropomorphic or non-anthropomorphic robotic hands, magnetic pick-up devices or pick-up devices based on suction cups or using materials that develop electrostatic adhesion forces, or else soft continuous-deformation grippers (soft robotics). The robot and the one or more arms of the robot might also not be provided with grippers, but with simpler ends (for example a rod fixed to their end), and one of the bodies of the robot or arms of the robot may also be used as an effector.

The robot may thus act on the environment (for example to carry out a physical action) or interact with the environment (for example to inspect it) with its one or more effectors, or else using objects held by the one or more effectors or fixed to the robot or to the end of its robotic arms.

The programming aid device according to the invention is particularly well suited to the programming of tasks carried out in complex environments that are naturally adapted to humans. In order for the robot 2 to be able to carry out various tasks therein, it may be advantageous for the effector, if it is a gripper, to take the form of an anthropomorphic robotic hand. Other types of effector may be envisaged, for example sensors, intended to carry out a measurement and/or inspection on the entity, remotely or in contact therewith.

It should be noted that the various elements of the programming aid system of the invention may communicate as much as necessary by wired or wireless communication means (not shown in the figures).

To program a task (a sequence of at least one action) of the robot, the operator 1 uses the first designation device 41 to point to the entity 310, for example a part 310 of the machine 31 or an object, using a light signal, advantageously in the visible spectrum. They then tell the robot an action to be carried out on this target via a human-machine interface, for example by speaking thereto in natural language if the designation device 41 or the robot or the environment is equipped with a microphone and software capable of understanding orders given orally, such as for example voice recognition software and a chatbot using a large language model or a foundation model adapted to voice interactions, or a human-machine interface comprising a screen or a human-machine touch interface if it is not possible to use voice commands.

The visibility confirmation device 42 makes it possible to confirm to the operator that the robot has indeed seen the target designated by the operator.

The one or more reachability confirmation devices (43, 44) are used to tell the operator whether the designated target is able to be reached by the robot or the one or more arms of the robot, whether or not this requires its movable base to be moved if the robot is provided therewith.

The robot uses action and trajectory planning software and/or a database of pre-learned actions (for example using a reinforcement artificial intelligence-based approach), known to those skilled in the art, to generate a program that allows it to carry out the task that the operator programs and teaches the robot, in relation to the designated entity.

The operation is repeated as many times as the process requires, the robot that the operator programs itself being adapted to the task to be carried out. By way of example, if this involves turning a part using the numerical lathe 31, it is possible to use a robot equipped with two robotic arms each equipped with an effector, and the sequence of actions may be composed of the following actions (elementary tasks) T1-T11, the designated entity 310 taking a different form in each stage:
T1: The operator designates (with the first designation device 41) a container containing rough stock to be turned, or directly designates a piece of rough stock in this container, and tells the robot (for example using a voice-controlled HMI or an HMI based on the use of a touchscreen) to pick up a piece of rough stock or this rough stock with one of its arms.
T2: They designate the jaws of the lathe and tell the robot to insert the rough stock between the jaws, in the axis of the jaws.
T3: They designate a button intended to close the jaws and tell the robot to press it with its second arm.
T4: They designate another button intended to close the protective cover and tell the robot to press it with its first arm, which no longer needs to hold the rough stock once it has been picked up between the jaws of the lathe, thereby preventing this arm from remaining “in the machine” when the cover is closed.
T5: They designate the on button of the lathe and tell the robot to press it with one of its arms.
T6: They designate the lathe operation visualization system (for example a control screen or the light column above the machine) and tell the robot the procedure to follow to wait for milling to be completed (for example an indicator light that lights up at the start of milling and goes out at the end).
T7: They designate the cover opening button and tell the robot to press it when milling is complete.
T8: They designate the jaws and tell the robot to pick up the part that will be in the jaws with one of its arms.
T9: They designate the jaw opening button again and tell the robot to press it with its other arm.
T10: They designate the container or table intended to receive the machined parts and tell the robot to deposit the finished part in this container or on this table.
T11: They tell the robot to perform these tasks again as long as rough stock is present.

Actions may be planned and trajectories may be generated in real time after each designation, or in a manner grouped at the end of the sequence, without this departing from the scope of the invention.

According to one embodiment, the visibility confirmation device 42 comprises a vision system and means for projecting a second pattern 426 (FIG. 3). The vision system comprises a vision sensor and signal processing means for determining whether the first pattern is within the field of view of the vision sensor allowing the robot to perceive its environment, and notably the entities designated by the operator. This vision sensor may for example take the form of a camera integrated into the robot or attached thereto or to another element of the environment, or else form part of a set of cameras all integrated into the robot or all attached thereto or all arranged on other elements of the environment or any combination of these possibilities.

Visibility may thus be understood to mean the ability of the vision system (vision device and associated algorithms) to recognize the projected pattern in the one or more images (if there are multiple cameras) (this implicitly assuming that this pattern is within the field of view of the one or more cameras (in terms of aperture and depth) and that it is not located in a shaded area).

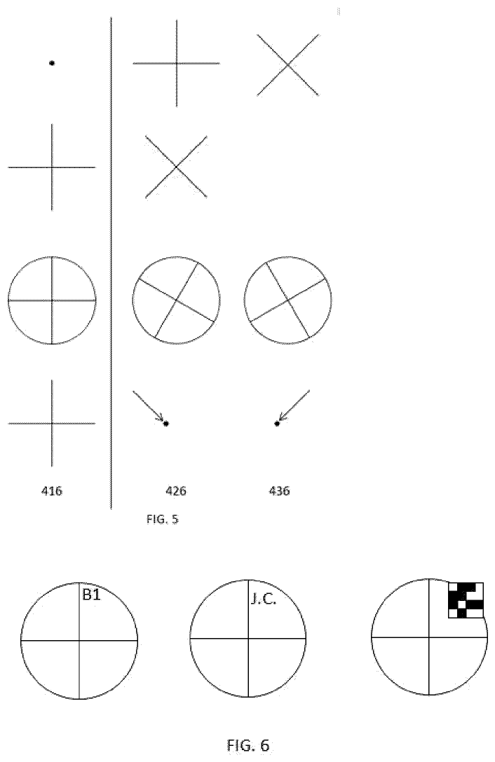

If the first pattern is within the field of view of the vision sensor (that is to say the first pattern is “visible”), the means for projecting the second pattern 426 may be used to project this second pattern 426 close to the first pattern (projected by the first designation device 41) or superimposed on this first pattern, such that the operator 1 looking in the direction of the first pattern 416 used to designate the entity 310 is able to see it easily. Projected “close” is understood to mean an at least partial overlap of the first pattern and the second pattern, with a level of superposition of the areas generated by the points furthest from these patterns greater than a threshold typically equal to 50% (that is to say the second pattern covers at least half the surface of the first pattern). “Superimposed” patterns is understood to mean that the barycentres of the two patterns, or a particular element of these patterns, for example the location where the segments that form said patterns intersect in the case of cross-shaped patterns (FIG. 4), are projected at the same location.

According to another embodiment, compatible with the embodiment described above, the reachability confirmation device comprises means for projecting at least one third pattern (436, 446). The means for projecting at least one third pattern (436, 446) may be carried by the effectors of the robot (a designation device 43 on a first effector and a designation device 44 on a second effector, if the robot comprises at least two arms), but they could also be arranged elsewhere on the robot or in the environment. To check whether the entity is able to be reached by the one or more effectors of the robot, it is possible for example to use the vision system and the associated signal processing means, in combination with knowledge about the positioning of the camera and the robot, to calculate the coordinates of the entity in the reference frame of the robot, and the models of the robot and of its one or more effectors to calculate the movements necessary to reach it and check whether they are able to be carried out. The third and fourth designation devices may then project a third and fourth pattern (436, 446, FIG. 3), close to the first pattern or superimposed on this first pattern, if the entity is able to be reached by the one or more effectors. Projected “close” is understood to mean an at least partial overlap of the first pattern and the third/fourth pattern, with a level of superposition of the areas generated by the points furthest from these patterns greater than a threshold typically equal to 50% (that is to say the third/fourth pattern covers at least half the surface of the first pattern). “Superimposed” patterns is understood to mean that the barycentres of these patterns, or a particular element of these patterns, for example the location where the segments that form said patterns intersect in the case of cross-shaped patterns (FIG. 4), are projected at the same location.

A “reachable area” is understood to mean an area for which the movement necessary for the effector to reach the area is able to be carried out by the robot (the same definition being able to be given for a “reachable entity”). The end of the movement corresponds to one configuration from among a set of configurations of the effector able to be reached by the robot, taking into account the characteristics (for example dimensions) and capabilities (for example articular movements) of the robot, the characteristics and capabilities of the effector, and the characteristics of the environment (position and orientation of the (fixed or mobile) base of the robot, the configuration of the entity, or else the absence of collisions with the environment).

The first designation device 41, the second designation device 42 and the third designation device 43 (or even the fourth designation device 44, if the robot has a second effector) may be of any type allowing the operator and robot to indicate the designated target, for example and non-exhaustively a point laser pointer or other laser pointer, or a miniature projector capable of projecting a point target or other target onto any type of medium. Such a projector may advantageously use a visible signal, so that the operator is able to see it, but it could also project a signal outside the visible spectrum (that is to say multispectral projection), for example in the infrared.

The one or more cameras may advantageously be equipped with a narrow-spectrum (single-band or multi-band) bandpass filter adapted to the types of signal projected by the designation devices (which may or may not all be of the same type, or of a different type, for example laser pointers and miniature projectors, operating in identical frequency bands or not, for example red, green and blue lasers).

The first pattern 416 projected by the device 41 held by the operator may be a point pattern, as on a laser pointer. This is the simplest solution but, if the operator is not used to it, they may have trouble identifying this pattern, and if they have trouble identifying this pattern, they will also have trouble projecting this pattern at the location they wish to designate. To avoid this problem, it is advantageously possible to use an (approximately) vertical or inclined cross-shaped target, which is easier to see. FIG. 4 illustrates various examples of targets comprising a cross.

For example, it is possible for this purpose to use lighting devices similar to those integrated on laser levels, without a gravity stabilization system as on said laser levels, and therefore able to be used to point to a target without any stabilization delay. To make the target even more explicit, it is also possible to use patterns taking the form of a crosshair combining straight lines and circles, or else a profile comprising elements, such as for example arrows, intended to guide the operator and facilitate convergence towards the target they wish to designate.

The shape of the patterns, their size, their colour and the thickness of the lines of the patterns may be adjusted depending on the context.

Moreover, the human-machine interface may be configured to make it possible to modify the shape, size or any other parameter of the first pattern, of the second pattern, of the third pattern (or of the fourth pattern, or of the subsequent patterns if there were to be more than four thereof) on the fly, so as to adapt to the current situation. For example, an arrow may be used to designate a target area for the base of the robot (that is to say a reference configuration in terms of position and orientation) on the ground, the visibility and reachability confirmations of this configuration then being able to take the form of crosses projected with different orientations.

The signal processing software of the vision sensor of the robot (which may for example be a camera) will be adapted depending on the choice of the shape of the first pattern, such that the robot easily recognizes the position designated by the user. One simple solution could consist in using the barycentre of the detected points, but this might not work correctly if the entire target is not visible or if the target is distorted because the surface onto which it is projected is not flat and perpendicular to the designation system 41. Preference will therefore be given to using a system capable of detecting the intersections of lines and/or the centres of circles, or a system based on advanced signal processing or artificial intelligence capable of recognizing the position of the centre of the pattern, whether the pattern is completely visible or only partially visible, and whether the pattern has the expected shape or a shape modified by the surface onto which it is projected, notably when this surface is not flat and perpendicular to the designation system 41.

To signify that they wish to designate an entity, the operator may illuminate it at a specific time by actuating the first designation device 41, or else they may activate the first designation device 41 over a longer period, to better see where it is pointing, and specify the targeted position by pressing a button at a specific time, which button may be integrated into the first designation device for simplicity or into a device held in the other hand so that pressing the button does not disturb aiming. It is of course also possible to use any other means to choose the time of targeting, for example and non-exhaustively a voice command, or a blink of the eyes, or a movement of an arm or leg identified by an additional system (camera, inclinometer, accelerometer, etc.).

As may be seen in FIG. 5, it is advantageous for the first pattern 416, the second pattern 426 and the third pattern 436 (or even each of the other patterns if the robot comprises multiple effectors) to be different from one another, such that the operator is able to easily distinguish them and quickly ascertain whether the entity is visible to and able to be reached by the arm that is to carry out the task.

It is also possible to use different colours to distinguish the various patterns. It should be noted that, to make it possible to distinguish the various patterns from one another, it is also possible to use, as shown in FIG. 6, profiles integrating a code associated with each pointing device (for example the initials of the operator for the first pattern 416, the references B1 and B2 for “arm 1” and “arm 2” for the patterns 436 and 446, or else a QR code, a barcode, or any other appropriate means).

These few examples are not limiting and/or could use any combination of type, colour and code to generate patterns that are easily distinguishable from one another, both for the operator and for the vision system of the robot.

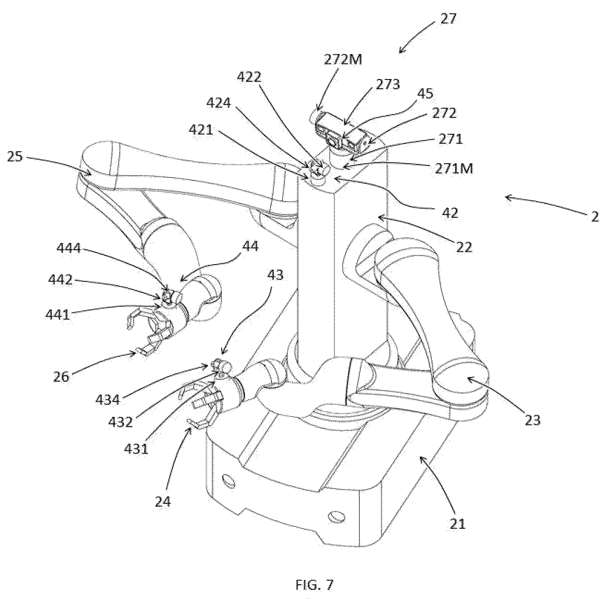

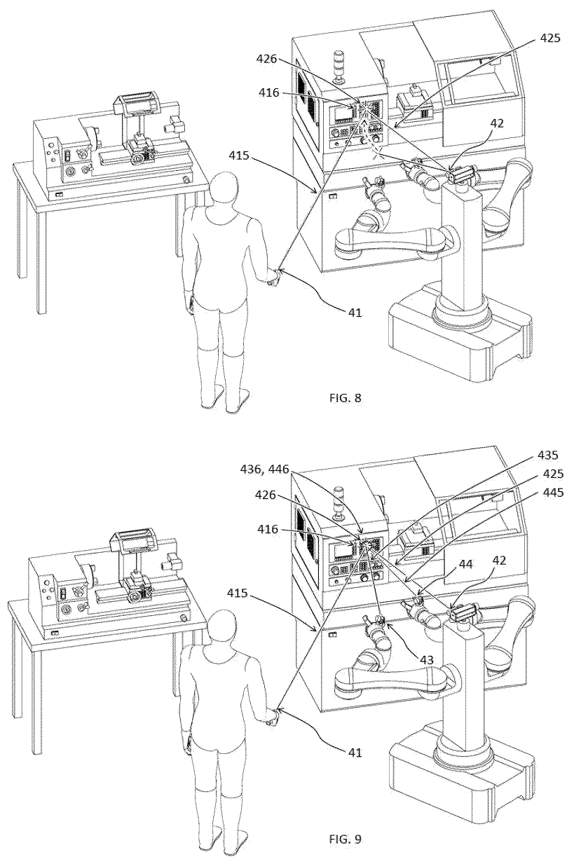

Once an entity has been designated by the operator, the visibility confirmation device 42 and the at least one reachability confirmation device (43, 44) make it possible to confirm that the robot has understood the orders given by the operator. In the example of FIG. 7, the robot 2 consists of a mobile base 21 capable of moving in a workshop (for example using wheels, tracks or legs), a trunk 22 (the height of which is fixed here but that could integrate one or more axes for modifying the height of the camera or more generally of the vision system and/or of the robotic arms), two robotic arms (23, 25) equipped with effectors (24, 26), and a vision system 27 comprising notably a vision sensor 273 (for example a camera, or any other vision system capable of acquiring an image of the patterns).

The vision sensor 273 of the vision system 27 is advantageously mounted movably on a structure consisting of the body 271, fixed to the trunk 22, and the mobile body 272, which make it possible, by virtue of the motorization systems 271M, integrated here into the body 271, and 272M, placed here on the side of the body 272, equipped with sensors and servo-control devices, to orient it along two non-concurrent axes. This type of pan-tilt structure is provided by way of example. It would of course be possible to use, instead of this mechanism, any other solution that makes it possible to modify the orientation of the vision sensor 273 of the vision system 27. The vision sensor 273 could also be fixed directly to the trunk 22 (or any other part of the robot), in particular if it has a wide enough field of vision (for example sensor or camera equipped with a fisheye lens, sensor or camera with a panoptic mirror, etc.).

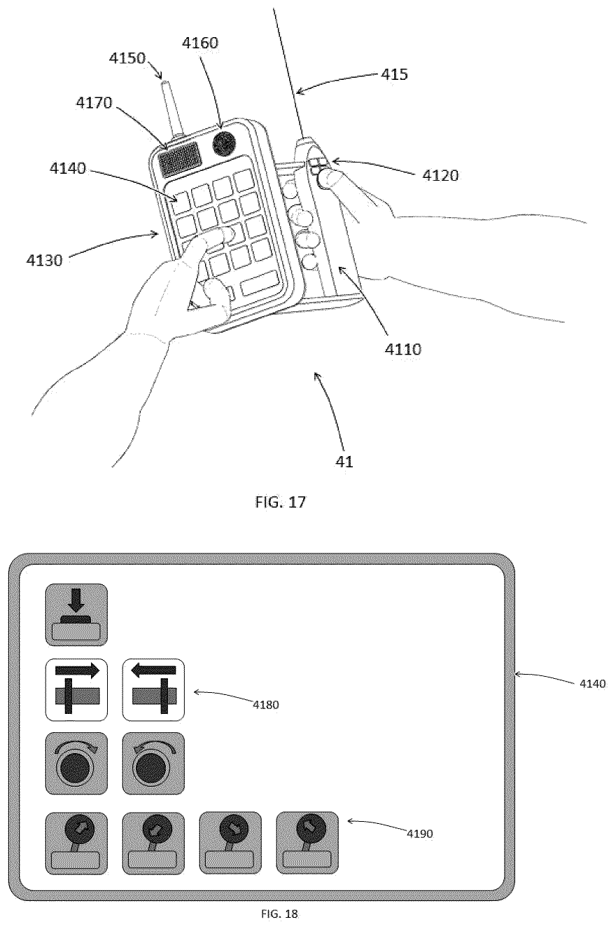

The vision system 27 may advantageously integrate artificial intelligence functions. This makes it possible to recognize the designated entity in order to propose contextual actions, as will be described later with reference to FIG. 18, and/or to use the designated entity as a reference to carry out the same task on all objects of the same type. For example, the operator may use the first designation device 41 to designate a nut to be unscrewed on a motor, and tell the robot 2 to recognize and unscrew all nuts of the same type.

In the example of FIG. 7, all three designation devices (42, 43 and 44) consist of an illumination system (a light source, for example a laser-based light source) (424, 434 and 444), mounted on an active (that is to say motorized and servo-controlled) pan-tilt structure formed by the mobile bodies (421-422, 431-432, and 441-442). This solution, which could be replaced by any equivalent alternative, makes it possible to modify, in controlled fashion, the orientation of the beams generated by the illumination systems (424, 434 and 444), and therefore to modify the position of the patterns that they generate. If the illumination system (424, 434 and 444) natively has the ability to project a complete image into a wide enough angular field (in the case for example of a micro-projector), the presence of pan-tilt systems (421-422, 431-432 and 441-442) is not necessary.

The operating principle of these devices will be better understood with reference to FIG. 8, which focuses on the visibility confirmation device 42, which is advantageously positioned close to the vision system 27 integrating the camera 273. This visibility confirmation device 42 makes it possible to tell the operator that the vision system has indeed seen the first pattern 416 generated by the first designation device 41. When the operator designates a reference position with the first designation device 41, the light beam 415 of this designation device generates a first pattern (a target) 416. If this first pattern is seen by the vision system 27, the visibility confirmation device 42 will be servo-controlled such that the second pattern (target) 426 generated by its light beam 425 is positioned at the same location as the first pattern 416. The colour of the second pattern 426 may advantageously be controlled depending on the situation, with for example a second pattern 426 that is green and at the same location as the first pattern 416 if the first pattern 416 is visible and the second designation device 42 manages to register this second pattern 426 on the first pattern 416, and red and/or at a location different from that where the first pattern 416 is located otherwise (for example if the target 416 is in the shadow of an object that obscures it for the vision system 27), by using multicoloured sources (for example multiple lasers or a projection system with multiple colours in the visible range). The servo-control of the second pattern 426 with respect to the first pattern 416 may be based:
either on absolute position servo-control, by using the vision system 27 to estimate the position of the first pattern 416 in the camera reference frame, and models of the robot and/or of the pan-tilt systems supporting the camera and the second designation device 42 to estimate this position in a reference frame common to the camera and to the second designation device 42.
or on relative visual servo-control that minimizes the discrepancy between the first pattern and the second pattern.

The servo-control may advantageously be carried out in real time throughout the movements of the operator, so as to capture the designated position on the fly, without any delay.

The servo-control that minimizes the discrepancy between the first pattern 416 and the visual rendering 426 of the visible character of the entity designated by the operator may be managed by a first servo-control unit.

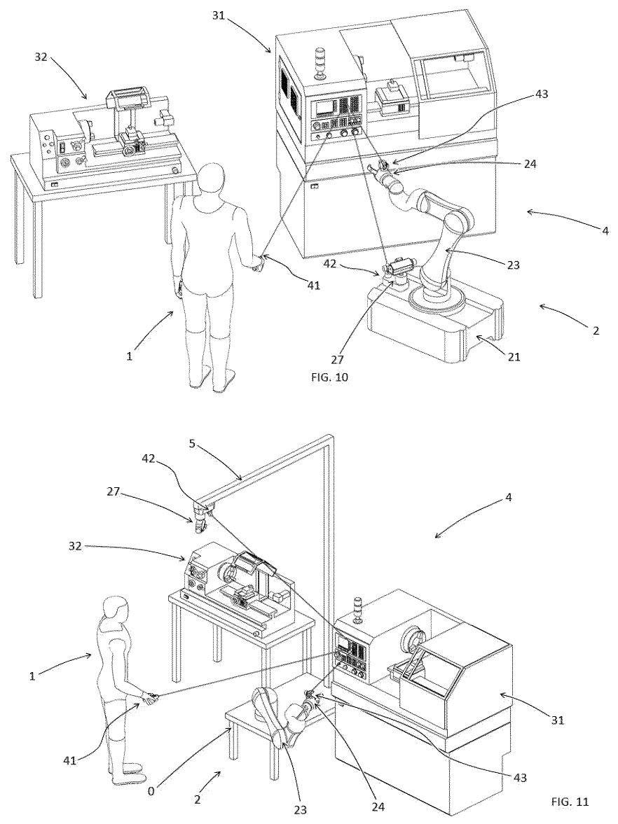

The principle is the same for the one or more reachability confirmation devices (43, 44), except that said one or more reachability confirmation devices are intended to display one or more patterns (for example one or more crosses or targets) that no longer depend on the visibility of the area designated by the operator, but on its ability to be reached by the robot or the one or more arms of the robot, as illustrated in FIG. 9 in the case where the robot comprises two arms and two effectors, and in FIG. 10 in the case where the robot comprises only a single arm and a single effector.

The servo-control that minimizes the discrepancy between the first pattern 416 and the visual rendering (436, 446) of the reachable character of the entity may be managed by a second and third servo-control unit (if the servo-control of the patterns 436 and 446 is managed by two separate control units) or by a single second servo-control unit (if the servo-control of the patterns 436 and 446 is managed by the same control unit), or else by the same servo-control unit as the servo-control that minimizes the discrepancy between the first pattern 416 and the visual rendering 426 of the visible character of the entity designated by the operator.

According to a first embodiment of the reachability confirmation device, the third or the third and fourth designation devices (43, 44), which are carried here by the effectors 24 and 26 of the robot 2 but which could be arranged elsewhere on the robot or in the environment, may project a third and fourth pattern (436, 446) close to the first pattern 416 or superimposed on the first pattern 416 if the entity is able to be reached by the one or more effectors. A second embodiment of the reachability confirmation device will be described with reference to FIG. 18.

Thus, the third pattern 436 produced by the light beam 435 generated by the reachability confirmation device 43, advantageously arranged close to the effector 24 of the arm 23 with which the reachability confirmation device 43 is associated, may advantageously be displayed in green, after convergence of the servo-control operations towards the position designated by the operator, if said position is able to be reached by the effector 24, and in red otherwise. Similarly, the fourth pattern 446 produced by the light beam 445 generated by the device 44, advantageously arranged close to the effector 26 of the arm 25 with which the device 44 is associated, may advantageously be displayed in green, after convergence of the servo-control operations towards the position designated by the operator, if said position is able to be reached by the effector 26, and in red otherwise. The servo-control of the third and fourth patterns (436, 446) with respect to the first pattern 416 and with respect to the second pattern 426 may use the same types of approach and model as the servo-control of the second pattern 426 with respect to the first pattern 416, while checking whether these patterns are able to be reached by the one or more arms of the robot will use the models of these arms, or of their workspace, or a digital twin. Checking the reachability of these patterns may also take into account the capabilities and movement models of the mobile base if the robot 2 is mobile and this robot is authorized to move in order to carry out the actions programmed by the operator.

In order to avoid the operator having to maintain their targeting for a long time, the patterns may advantageously be made to converge in two stages, the second pattern 426 firstly being servo-controlled very quickly (in real time) with respect to the first pattern 416, which may be subject to the user's shaking, and the second pattern 426 secondly being used as a fixed reference for the servo-control, as quickly as possible but not necessarily in real time, of the third and fourth patterns (436, 446). Of course, it is also possible to servo-control the second pattern 426 and the third and fourth patterns (436, 446) with respect to the first pattern 416 in real time.

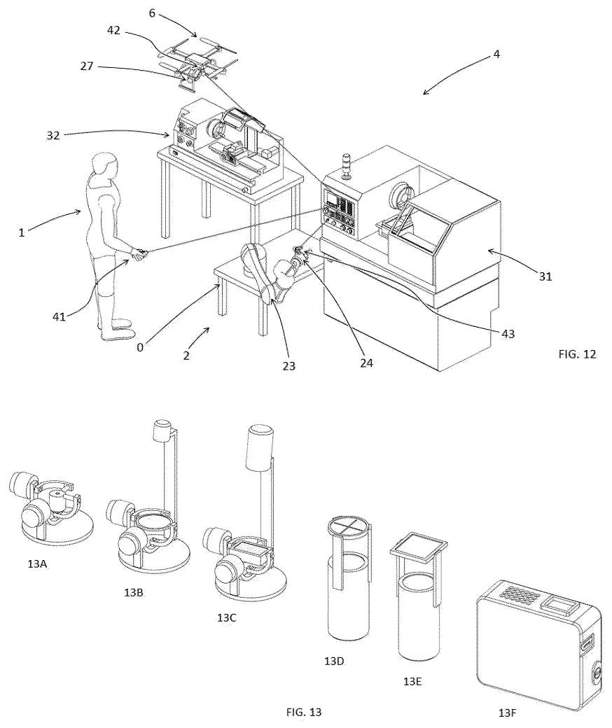

FIGS. 11 and 12 illustrate another example in which the robot 2 is fixed. More specifically, it is fixed to a support 0 that is expediently arranged so as to give the best possible access to the machines that the robot serves in the workshop. As in FIG. 10, this robot comprises only one arm 23 provided with a single gripper 24 (but it could also comprise multiple arms). To have the best possible visibility, the vision system 27 may be fixed to a pole 5 (here integrated into the support 0, but this pole could be independent of the support of the robot, and the camera could also be fixed elsewhere, for example to the ceiling of the workshop, or to a bridge crane) or carried by a drone 6, this pole or this drone also integrating the second designation device 42. As in FIG. 10, the device 4 here comprises only three target projection devices: the first designation device 41 held by the operator, the second designation device 42 and the third designation device 43.

As indicated above, the patterns may be generated, when they are point patterns, cross-shaped or formed of simple geometric elements, by devices such as those integrated into pointers or laser levels. The advantage of laser-based solutions lies in their robustness to lighting conditions.

To generate more complex profiles, it is possible, as shown in FIG. 13, to use a servo-controlled laser spot (laser pointer mounted on an orientable parallel platform with two motorized and controlled axes, cf. 13A), or a servo-controlled mirror reflecting a laser spot (fixed laser pointer and mirror mounted on an orientable parallel platform with two motorized and controlled axes, cf. 13B), or an array of micro-mirrors (for example of the same type as those used in DLP projectors) reflecting a laser spot or a high-intensity image (cf. 13C), or else a perforated mask (cf. 13D) or an LCD screen/panel (cf. 13E) located opposite a high-intensity non-point light source that may be of adjustable colour and filter the light projected by this light source. The advantage of solutions that do not use a laser lies in their lower dangerousness.

These laser-based or high-intensity light source-based solutions are inexpensive, but it is also possible to use a miniature video projector (13F), if there are fewer cost and space constraints to be complied with.

Of course, these examples are not limiting, and it is possible to use any solution or combination of solutions to achieve the same result:
fixed or mobile emissive solutions (for example laser source, VECSEL, LEDs, bulb, miniature projector, etc.) in point or multiple or matrix form;
transmissive solutions (for example more or less complex mask, LCD panels, etc.);
reflective solutions (for example mirror mounted on a motorized gimbal, DLP panel, etc.).

These devices may, if necessary, implement optical means known to those skilled in the art and outside the strict scope of the invention to ensure the optical quality of the profile regardless of the projection distance.

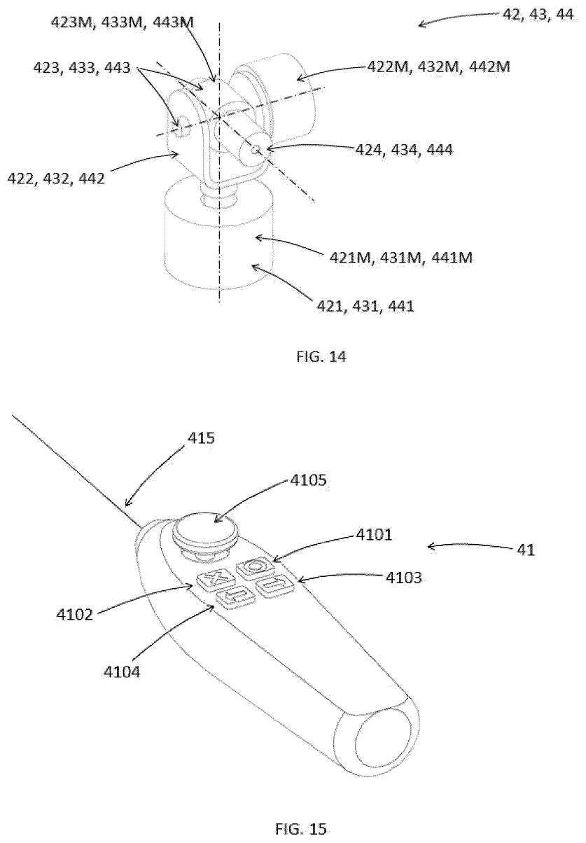

FIG. 14 illustrates one embodiment in which the designation devices may be equipped with an additional degree of freedom to modify the orientation of the projected pattern in controlled fashion by rotating the lighting device about its axis. Each of the designation devices thus comprises the pan-tilt system (421-422, 431-432, 441-442), equipped with the motorization, measuring and control means (421M-422M, 431M-432M, 441M-442M), the body (423, 433, 443) arranged at the output of this device and the lighting system (424, 434, 444), the angle of which about its axis may be modified using the motorization, measuring and control means (423M, 433M, 443M).

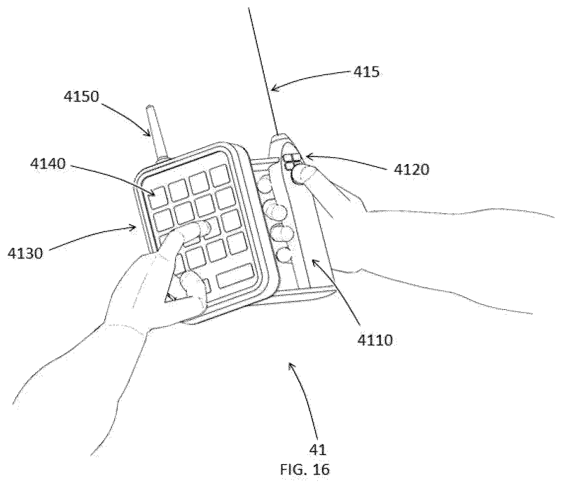

To facilitate the designation of the reference entities or the position of these entities and the programming of the actions associated with these entities or these positions, the system for aiding the programming of a robot 4 furthermore comprises a human-machine interface (HMI), which may (optionally) be integrated into the first designation device 41. The HMI may comprise, for example and in a very simple version, a set of pushbuttons, as illustrated in FIG. 15. In this example, the first designation device 41 is provided with a button 4101 for designating an entity, that is to say an object of interest or a part thereof or an area of the environment (the button 4101 makes it possible to indicate when the position of the target generated by the light beam 415 should be taken as a reference by the robot), a button 4102 for cancelling the current designation, a button 4103 for moving to the next stage, and a button 4104 for returning to the previous stage. This HMI may also be used to facilitate the replaying of positions and actions that have been “learned” (that is to say the repetition of these actions). The second designation device and the third and fourth designation devices may then be used so that the robot shows the successive positions that have been programmed and the associated actions (for example, the second device may point to the area associated with a given action and the third and fourth devices to signify the associated action, for example by moving the target in the direction in which the one or more arms of the robot should move in this stage). This replaying of the various “learned” stages may be launched at the request of the operator, for example via the mini-joystick 4105. The robot may be allowed to “replay” all the stages, or navigate through them, for example by pressing the button 4103 to move to the next stage or the button 4104 to return to the previous stage.

Thus, with the pointing devices of the present invention, the operator is easily able to designate entities, and see whether they are visible to the vision system 27 allowing the robot 2 to perceive its environment, and able to be reached by the robot 2. To check that an entity is visible, it is possible for example to use the signal processing means associated with the vision system 27. If these signal processing means detect the first pattern 416 used to designate this entity and thus confirm that the first pattern 416 is within the field of view of the vision sensor 273 of the vision system 27, the entity will be classified as “visible”, and this visible character will be indicated to the operator by the projection of the second pattern 426 close to the first pattern 416 or superimposed on this first pattern 416. To check whether the entity is able to be reached by the one or more effectors of the robot, it is possible for example to use the vision device 27 and the associated signal processing means, in combination with knowledge about the positioning of the camera and the robot, to calculate the coordinates of the entity in the reference frame of the robot, and the models of the robot and of its one or more effectors to calculate the movements necessary to reach it and check whether they are able to be carried out, in which case the entity will be classified as “reachable”. This reachable character will then be indicated to the operator by the projection of the at least third pattern (436, 446) close to the first pattern 416 or superimposed on this first pattern 416, such that this reachable character is easily understandable to the operator, for example by projecting this at least third pattern (436, 446) in green.

If the entities designated by the operator are not visible and/or reachable, they may move the robot, for example by moving it “by hand” in the case of a collaborative robot, or ask it to move, for example using a voice command (for example “move 50 centimetres forwards”), or using a remote control, or else by using the device 41 to designate a different position on the ground and asking the robot, for example using a voice command, to reach it with its mobile base. The projected pattern may then advantageously be an arrow. When used to designate a position on the ground, and not to confirm acquisition thereof as was illustrated in FIG. 5, such a pattern advantageously makes it possible to tell the robot both the position to be reached and the orientation that the mobile base should have in this position.

If the objective is to control the movements of the base of the robot, it may be sufficient to use a very simple HMI integrated into the pointing device, such as the one illustrated in FIG. 15. The button 4101 may for example be used to move the robot forwards, the button 4102 may be used to move it backwards, the button 4103 may be used to turn it or move to the right, and the button 4104 may be used to turn it or move to the left. As an alternative, it is possible to use the mini-joystick 4105 to control the movements of the base of the robot, thereby making it possible to free up the buttons 4101 to 4104 for other functions (of course, the iconography of the various buttons will be adapted to the functions that they carry out; by way of example, the arrows on the keys 4103 and 4104 may adopt shapes different from those illustrated in FIG. 15), or a voice command.

If the entities are visible and reachable, the operator may use any suitable means to tell the robot the action to be carried out at the designated position. As with the control of the mobile base, the operator may use a voice command (for example using a lavalier microphone, or a microphone integrated into the designation device they are holding in their hand, as illustrated in FIG. 17) or an HMI integrated into the objective designation device 41. A button-based HMI, such as the one illustrated in FIG. 15, may of course be used here as well, but it may be useful, if the environment comprises a large number of objects or controllers to be actuated, to have a larger number of buttons that are physical and predefined, physical and reconfigurable, or that appear on a fully reconfigurable and reprogrammable touchscreen, so as to adapt to the environment.

The variant of the objective designation device illustrated in FIGS. 16 and 17 comprises, for example, in addition to an input area 4110 and a first area 4120 intended primarily to manage the light beam 415, a second area 4130 integrating a more advanced HMI 4140 that may comprise a more complete operating panel or a touchscreen (which is advantageously reconfigurable and reprogrammable). This second type of HMI 4140 may advantageously comprise:
physical or digital buttons for further constraining the movements of the robot, for example to ensure that it arrives perpendicular to the surface designated by the pattern generated by the beam 415 (this surface and its normal being identified using software for processing the data provided by the vision system 27 or known by virtue of a digital twin of the workstation, calibrated or not calibrated with the data provided by the vision system 27), or at another angle, for example at 45°, by virtue of suitable icons easily understandable to the operator.
and physical or digital buttons for telling the robot the actions to be carried out at the location designated by the target, for example press a button, move a cursor, turn a wheel or move a lever, again by virtue of suitable icons.

There are various solutions known to those skilled in the art for identifying the local geometry of the entities designated by the operator based on data or images provided by the vision system, for registering a digital twin with these data, or for recognizing and identifying objects located at the locations designated by the operator. Any one of these may be chosen, whether based on artificial intelligence or not, without this departing from the scope of the invention.

The variant of the human-machine interface illustrated in FIG. 17 differs from the one illustrated in FIG. 16 in that it comprises audio interfaces at input (that is to say one or more microphones 4160) and at output (that is to say one or more loudspeakers 4170). The one or more microphones allow the operator to supplement their instructions with voice commands. For example, they may tell the robot to arrive perpendicular to the surface of the designated entity (rather than using a button on the HMI to do this) while at the same time using a button to indicate the action to be taken. The one or more loudspeakers, for their part, allow the robot to indicate that it has indeed taken into account the operator's instructions, in addition to the use of the second, third and fourth designation devices. Of course, and as has already been described above, it is also possible to use another audio interface for this purpose, for example and without limitation a lavalier microphone and an audio headset, and it is possible to use any combination of voice commands and commands using physical buttons or a touchscreen to program the robot.

In addition, the variants of the HMI illustrated in FIG. 16 and FIG. 17 comprise an antenna 4150 that forms part of the means for communication between the various components of the device 4 of the present invention.

A second embodiment of the reachability confirmation device is described with reference to FIG. 18. According to this second embodiment, the visual rendering of the reachable character of the designated area is not formed by the projection of a third (or even a fourth) pattern, but by a display of contextual icons 4180 by the human-machine interface 4140, the icons being displayed depending on a reachability context of the one or more effectors (24, 26) with respect to the entity 310 (if there are multiple effectors, the contextual icons will be displayed successively for each of the effectors, or simultaneously in two different areas of the HMI 4140, with means for distinguishing those relating to one of the effectors and those relating to the other effector, for example using distinctive messages, for example R1 and R2 for robot 1 and robot 2, or icons of different colours).

Thus, according to the second embodiment, to program a robot task, the operator 1 uses the first designation device 41 to point a light beam at the entity 310. The visibility confirmation device 42 makes it possible to confirm to the operator that the robot has indeed seen the target designated by the operator. They then tell the robot an action to be carried out on this target via the human-machine interface 4140, which displays, if the entity 310 is also reachable, icons representing the actions able to be carried out by the one or more effectors of the robot on this entity (and only these icons). In FIG. 18, the selection of displayed icons corresponds for example to actions of pressing a button, moving a cursor to the left or to the right, moving a rotary knob to the left or to the right or moving a control knob in various directions.

According to one embodiment, icons that are not relevant to the action of the effector may be greyed out, or displayed with a lower brightness level, or might not be displayed at all. In FIG. 18 for example, the icons 4190 that are not relevant to the action of the effector have a greyed-out background, and the icons 4180 that are relevant to the action of the effector have a white background.

The contextual display of icons thus allows the operator to program only tasks relating to entities able to be reached by the one or more effectors of the robot.

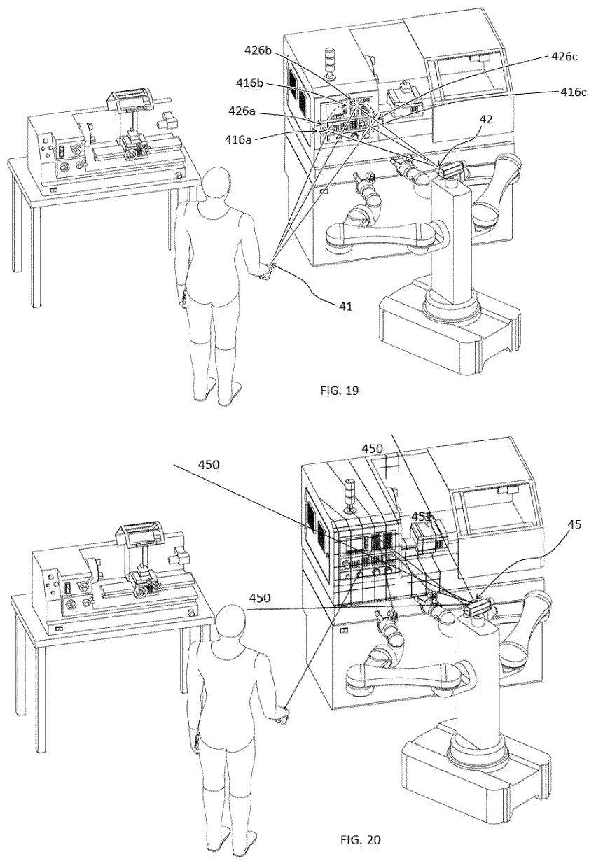

According to one embodiment illustrated in FIG. 19, the successive positions of the entities designated by the operator using the first designation device 41 (denoted 416a, 416b and 416c in FIG. 19) are advantageously recorded by the robot, such that they are able to be “replayed” by the visibility confirmation device 42 (points 426a, 426b and 426c) in order to check, adapt or change the scenario (the visibility confirmation device 42 may also be used to visualize the projection, onto the immediate environment of the designated positions, of the trajectory of the robot, generated by its control software based on the learned positions).

As has been indicated above, for the programming aid system to work, the robot must be able to see the first pattern projected by the operator, even if the robot has to be moved if the first pattern is not within the field of view of the robot. Confirmation of visibility is thus generally carried out a posteriori.

To make it easier for the operator to check that the first pattern will be visible a priori, it is conceivable, according to one embodiment illustrated by FIGS. 20 and 21, to use an additional projection device 45. As shown in FIG. 20, this device may be used to project a grid or any other profile that makes it possible to help the operator visualize the field of view of the vision system 27, that is to say what the robot is able to see.

In FIG. 7, an additional projection device 45 is fixed to the vision sensor 273 of the vision system 27, here a 3D camera. The additional projection device 45 is advantageously fixed between the two optics of the 3D camera so that the projection is carried out from a configuration that is as close as possible to the axis of the camera 273. Of course, the additional projection device 45 could take a different form for another type of sensor. It could for example be an annular device positioned around the lens on a 2D camera.

The “limits” of the field of view of the robot, illustrated by the references 450 (FIG. 20), are not actually visible (unless they are projected into an augmented reality headset worn by the operator). Only the projected profile, which is advantageously as close thereto as possible, is visible. This process may generate “shaded areas” produced by the environment (for example the rail and machining head 451 in FIG. 20) or by the one or more arms of the robot. To prevent shaded areas produced by the robot, the arms of the robot may be moved. As an alternative, the vision sensor could form part of a set of cameras all integrated into the robot or all attached thereto or all arranged on other elements of the environment or distributed on the robot and in the environment, as has been explained above. In this case, it would be possible to use, without departing from the scope of the invention, multiple additional projection devices 45, each associated with one of the cameras of all or part of the set of cameras.

It is possible to use two colours (generated for example by two laser sources) to distinguish between areas 452 that are within the field of view of the robot and within the optimum area of view of the sensor and areas 453 that are within the field of view but at an excessively great (or excessively small) depth for the camera to be able to see them correctly.

In FIGS. 20 and 21, the field of view of the camera of the robot is visualized using laser lines, the spacing between which may advantageously be adjusted depending on the precision that it is desired to obtain. It would also be possible to project “colour spots” described in the articles [Wilkinson1] and [Wilkinson2], but such spots are not necessarily suitable in an industrial environment that may contain other sources of coloured light.

Generally speaking, by designating entities that are located in the area scanned by the projection device 45, and in particular those that are within the field of view of the robot and within the optimum area of view of the sensor, the operator may be certain that these entities will be visible to the robot.

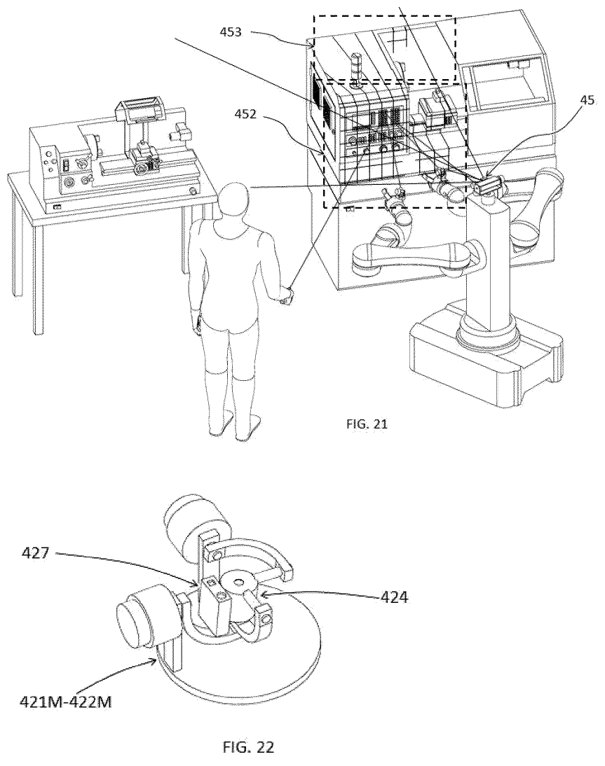

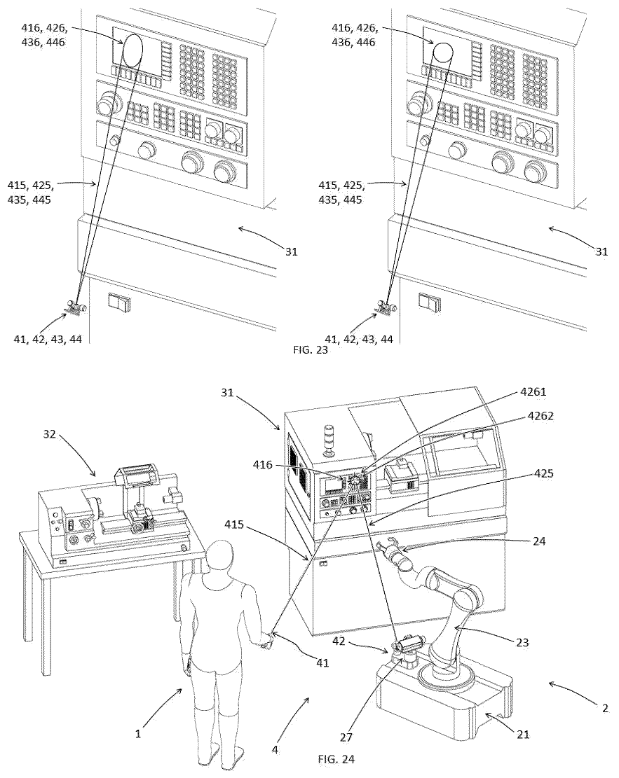

According to one embodiment illustrated in FIG. 22, the visibility confirmation device 42 and/or the one or more reachability confirmation devices (43, 44) may advantageously integrate a distance sensor 427 (for example an ultrasonic, capacitive, time-of-flight laser-based, phase-shift laser sensor or the like) in order to estimate the distance between the light source (424, 434, 444) of the designation device and the projected pattern (whether the second and/or the third and/or the fourth pattern).

This, in combination with the information about the configuration of the robot 2 and/or of the pole 5 or of the drone 6, allows the vision system and the designation devices to calculate the absolute position of the designated entity in the reference frame of the robot or in the reference frame of the workshop, which may be useful for generating the trajectories of the robot. Such a distance sensor may also be integrated into the first designation device 41, which will then have means for estimating the position of the first pattern 416 in a reference frame tied to the designation device 41. This device may also be equipped with measuring means (accelerometers and gyrometers and/or a motion capture device for example) for measuring its configuration in space, in order to be able to estimate the absolute position of the first pattern 416 here as well.

As illustrated in FIG. 23, the distance sensor may be integrated as close as possible to the beam of the designation devices (41, 42, 43, 44), in order to measure its length at all points of the profile generated. The first designation device 41, the visibility confirmation device 42 and/or the one or more reachability confirmation devices (43, 44) may furthermore comprise a means for correcting the shape of the first pattern 416, respectively the visual rendering 426 of the visible character of the entity 310 and/or the visual rendering (436, 446) of the reachable character of the entity 310. This correction may for example be obtained by modifying the profile generated by the mobile platform of the devices 13A, 13B or 13C illustrated in FIG. 13 depending on the discrepancy between the expected distance and the distance measured at each point of this profile, or else by modifying the control of the reflective or transmissive elements of the devices 13C, 13D and 13E, or of the image generated by the projector 13F.

This solution has the advantage of making it possible, if necessary, to correct the shape of the projected profile in real time so that it always remains similar and intelligible to the operator.

For example, in the left-hand part of FIG. 23, it may be seen that the first pattern 416 is greatly elongated, because of the off-axis position of the beam 415 coming from the first designation device 41, with respect to the normal to the illuminated area. In the right-hand part of FIG. 23, the correction means applies a correction to the projected shape so that the operator is able to see the pattern usually expected. Of course, these corrections could be triggered by any other means for detecting the angle between the light beams and the surface onto which they are projected. For example, it is possible to use the digital twin of the scene and/or advanced vision algorithms, based on artificial intelligence or not, to reconstruct the local surface onto which the patterns are projected and correct them depending on the characteristics of this surface. The distance sensor integrated into the designation device remains a simple means for evaluating the position and the environment close to the designated entity. This embodiment also allows vision systems to recognize projected patterns more easily.

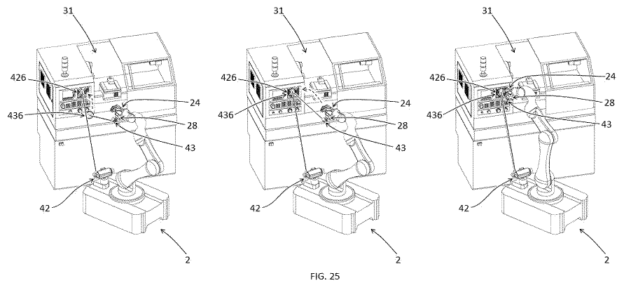

In another embodiment illustrated in FIG. 24, in which the robot comprises only one arm 23 equipped with a gripper 24 (but it could also be equipped with multiple arms and multiple grippers, and it could be equipped with one or more effectors that are not grippers, such as for example tools, sensors or inspection systems, based on vision or any other measuring technique), the visibility and reachability confirmation patterns for the entity designated by the pattern 416 are generated by the same designation device, here the device 42 associated with the vision system 27 and the beam 425 of which generates the patterns 4261 (equivalent to the pattern 426) and 4262 (equivalent to the pattern 436).

In this case, it is not necessary to integrate a designation device on the arm 23 or the gripper 24, and such a device does not appear in FIG. 24, but it would of course also be possible to retain only the designation device 43 associated with the robot and not the one associated with the camera, the designation device 43 being used to generate a pattern equivalent to the pattern 426 and a pattern equivalent to the pattern 436.

It would also be possible to retain the designation devices 42 and 43 and, depending on the conditions (and in particular the shadows projected by the robot or other elements of the environment), use either the designation device 42 associated with the vision system or the designation device 43 associated with the robot to project both the visibility and reachability confirmation patterns. It would also be possible to use the projection device 45 to generate all or some of the patterns (426, 436, 446), or any combination of the devices (42, 43, 44, 45).

This embodiment offers a saving in volume, since only one device is needed to project both the visibility confirmation pattern and the one or more reachability confirmation patterns. For this purpose, the device that is used must be capable of projecting two or more different profiles.

According to one embodiment of the invention, the visibility confirmation device 42 and/or the reachability confirmation device (43, 44) may also be used while the robot is carrying out tasks, in order to carry out visual servo-control with respect to the second or third pattern. As illustrated by the three diagrams in FIG. 25, the robot 2 is advantageously equipped with an additional camera 28 arranged close to the end of the arm 23 or on the effector 24, and the second and third designation devices advantageously use laser beams so that the profiles that are generated are easily visible to the additional camera 28 (including for tasks such as tree pruning, which are carried out outdoors where brightness may vary greatly).

The operating principle is then as follows: if the second and third designation devices are distinct, the third designation device is firstly, and only if necessary, controlled so as to make the third pattern 436 and the second pattern 426 converge, convergence being monitored in real time by the vision system 27 and/or by the additional camera 28. Secondly, the robot is controlled so that the effector reaches the area designated by the second pattern 426 and the third pattern 436, using visual servo-control with respect to one of these patterns. However, it is not necessary to use both patterns to control the robot. It is possible to use only one of them, for example the one generated by the visibility confirmation device 42.

Visual servo-control with respect to patterns generated by the robot itself could also be used if the reference positions of these patterns were not designated by the operator but by an automatic system, for example based on artificial intelligence, used for example in the field of agriculture, to autonomously locate fruit to be picked or branches to be pruned.

The invention as described facilitates the programming of any type of robot for any type of application. Industrial applications are targeted in particular (but not exclusively). It is also conceivable to use it in the field of agricultural robotics, by designating a specific type of fruit or vegetable and/or one with a specific level of ripeness and telling the robot to pick all fruits or vegetables of the same type and/or that are also ripe, or by designating a type of plant to be pulled up and telling it to pull up all plants of the same type. It may also be used in the field of inspection and maintenance, by asking the robot to inspect the designated area in more detail, or to identify all defects similar to the one designated by the operator, and generally in all situations where designating a specific object or area makes it possible to easily indicate a location of interest to a robot.

### DOCUMENTS CITED

[Wilkinson1] A. Wilkinson, A. Sinclaire, H.A. Yanco, ‘Spatial Augmented Reality User Interface for Assistive Robot Manipulation’, Proc. ACM/IEEE Workshop on Virtual, Augmented, and Mixed Reality for Human-Robot Interactions, Stockholm, Sweden, 13 March 2023, pp. 1-5
[Wilkinson2] A. Wilkinson, M. Gonzales, P. Hoey, D. Kontak, D. Wang, N. Torname, A. Sinclaire, Z. Han, J. Allspaw, R. Platt, H. Yanco, ‘Design guidelines for human-robot interaction with assistive robot manipulation systems’, Paladyn, Journal of Behavioral Robotics 2021, Vol. 12, No. 1, Jan. 2021, pp. 392-401

1. A system for aiding the programming of a robot capable of carrying out at least one action on an entity, comprising:
a first designation device, configured to allow an operator to designate an entity by projecting a first pattern onto the entity;
a visibility confirmation device, configured to provide the operator with a visual rendering that the first pattern is visible to the robot;
at least one reachability confirmation device, configured to provide the operator with a visual rendering that the entity is able to be reached by an effector of the robot;
a human-machine interface, configured to receive at least one command, provided by the operator, for interaction of the robot with the entity.

2. The system according to claim 1, wherein the command is validated only if the visible character of the first pattern and the reachable character of the entity are confirmed.

3. The system according to claim 1, wherein the visibility confirmation device comprises a vision system and means for projecting a second pattern onto the first pattern if the first pattern is within the field of view of the vision system.

4. The system according to claim 1, wherein the reachability confirmation device comprises means for projecting at least one third pattern onto the first pattern if the entity is able to be reached by the effector.

5. The system according to claim 3, wherein the first pattern, the second pattern and the third pattern are different from one another.

6. The system according to claim 3, wherein the visibility confirmation device is configured to modify the colour of the second pattern depending on whether or not the first pattern is visible to the vision system.

7. The system according to claim 4, wherein the reachability confirmation device is configured to modify the colour of the third pattern depending on whether or not the entity is able to be reached by the robot or the effector.

8. The system according to claim 1, wherein the visual rendering of the reachable character of the designated area comprises displaying contextual icons by way of the human-machine interface, the icons being displayed depending on a reachability context of the effector with respect to the entity.

9. The system according to claim 1, comprising a projection device configured to illuminate the entire field of view of the robot.

10. The system according to claim 9, wherein the projection device is configured to project a grid of lines the spacing between which is adjustable depending on the desired precision.

11. The system according to claim 1, wherein the first designation device, the visibility confirmation device and/or the reachability confirmation device comprise a means for correcting the shape of the first pattern, the visual rendering of the visible character of the first pattern and/or the visual rendering of the reachable character of the entity, respectively.

12. The system according to claim 11, comprising an image processing software unit configured to determine the distance between the effector and the entity, or a distance sensor configured to determine the distance to the entity, the correction means applying a correction depending on the determined distance.

13. The system according to claim 1, wherein the visibility confirmation device and the reachability confirmation device are integrated into one and the same structure, which is configured to project both the pattern of the visual rendering of the visible character of the first pattern and the pattern of the visual rendering of the reachable character of the entity.

14. A method for aiding the programming of a robot capable of carrying out at least one action on an entity, comprising:
a first step of designating an entity by projecting a first pattern onto the entity;
a second step of providing a visual rendering that the first pattern is visible to the robot;
a third step of providing a visual rendering that the entity is able to be reached by an effector of the robot;
a fourth step of receiving at least one command, provided by the operator, for interaction of the robot with the entity.

15. The method according to claim 14, wherein the command is validated only if the visible character of the first pattern and the reachable character of the entity are confirmed.

16. A computer program product comprising instructions for carrying out a method according to claim 15 when the program is executed by a processor.
